(19) United States
(12) Patent Application Publication
(10) Pub. No.: US 2026/0128646 A1
(43) Pub. Date: May 7, 2026

(54) STATOR FOR AN ELECTRIC MACHINE, ELECTRIC MACHINE, AND MACHINE-GEARBOX ARRANGEMENT

(71) Applicant: HELLA GMBH & CO. KGAA, Lippstadt (DE)

(72) Inventors: Bodo Buecker, Arnsberg (DE); Tobias Engel, Lippstadt (DE); Matthias Humpe, Oelde (DE); Tobias Lass, Warstein (DE); Guido Schniederjohann, Geseke (DE); Christoph Schulte, Paderborn (DE); Thomas Valeiras Fernandez, Lippstadt (DE); Katrin Zimmermann, Soest (DE)

(21) Appl. No.: 19/379,932

(22) Filed: Nov. 5, 2025

(30) Foreign Application Priority Data
Nov. 6, 2024 (DE) 102024132280.2

(51) Int. Cl. H02K 7/116; H02K 1/14; H02K 3/18

(52) U.S. Cl. CPC H02K 7/116; H02K 1/14; H02K 3/18

(57) ABSTRACT

The present invention relates to a stator for an electric machine. The stator includes an annular stator body and a plurality of stator windings arranged on the stator body. The stator body includes a circular segment, which extends along a circular path, and a recess segment, which has a radially inwardly deviating course from the circular path. The stator windings are arranged on the circular segment. The present invention further relates to an electric machine including: a stator, and a rotor arranged to be rotatable about a rotor axis of rotation within the stator body. The present invention further relates to a machine-gearbox arrangement including: an electric machine, a first gear wheel, a second gear wheel, and an element which is non-rotatably connected to the second gear wheel, wherein the element is arranged at least partially in a region between a recess segment and the circular path.

### CROSS-REFERENCE TO RELATED APPLICATIONS

The present application claims the benefit of German Patent Application DE 10-2024-132-280.2, filed Nov. 6, 2024, the disclosure of which is incorporated by reference.

### BACKGROUND OF THE INVENTION

The present invention relates to a stator for an electric machine, comprising an annular stator body and a plurality of stator windings arranged on the stator body. The present invention further relates to an electric machine comprising: such a stator and a rotor arranged rotatably about a rotor axis of rotation within the stator body. The present invention further relates to a machine-gearbox arrangement comprising: such an electric machine, a first gear wheel which is arranged to rotate with the rotor, a second gear wheel which is arranged in engagement with the first gear wheel, and an element, for example, a gear shaft or a third gear wheel, which is non-rotatably connected to the second gear wheel. Such a machine-gearbox arrangement is known from DE 10 2023 101 992 A1.

### SUMMARY OF THE INVENTION

The object of the present invention is to enable a relatively free and space-saving design of a gear stage formed by the first gear wheel and the second gear wheel in a machine-gearbox arrangement of the type mentioned above.

According to the invention, this object is achieved by a stator for an electric machine, an electric machine, and a machine-gearbox arrangement with the features of the embodiments disclosed herein.

The stator for an electric machine according to the invention comprises an annular stator body, i.e. a stator body rotating around a center point. In principle, the stator body may have any shape as long as it forms an annular structure. Preferably, the stator body forms a self-contained, uninterrupted annular structure. However, it is also conceivable in principle that there is an interruption in the annular structure. According to the invention, the stator body in each case comprises at least one circular segment which extends along a circular path, and at least one recess segment which has a radially inwardly deviating course from the circular path. The stator body thus comprises at least one substantially circular section, at least one circular segment, and at least one section that deviates from the circular shape, specifically one that is recessed radially inward, the at least one recess segment. If the stator body comprises several circular segments, these preferably all run along the same circular path. In principle, at least one recess segment may have any radially inward deviation from the circular path of at least one circular segment, for example, a straight line or a radially inward V-shaped or U-shaped course. The stator body consists of a magnetizable, preferably ferromagnetic, material. In principle, the stator body may be designed as a monolithic solid body or as a laminated core.

The stator for an electric machine according to the invention further comprises several, preferably six, stator windings designed in a fundamentally known manner for generating a magnetic field driving a rotor of the electric machine. According to the invention, the stator windings are arranged concentrically with respect to a center point of the circular path along which at least one circular segment extends, on at least one circular segment of the stator body. According to the invention, the stator windings are therefore arranged adjacent to at least one circular segment of the stator body. According to the invention, at least the center axes of all stator windings are therefore located in the angular region of at least one circular segment, wherein the angular region refers to the center point of the circular path. Preferably, the stator windings are located completely within the angular region of at least one circular segment. If the stator body comprises several circular segments, the stator windings are preferably evenly distributed over the several circular segments, i.e. an equal number of stator windings are preferably arranged adjacent to each of the circular segments. Preferably, all stator windings have the same number of turns. However, it is also conceivable that the stator windings have different numbers of turns.

Due to the fact that the stator body comprises at least one recess segment, the element of a machine-gearbox arrangement of the above-mentioned type realized with the stator according to the invention, which is non-rotatably connected to the second gear wheel, can be arranged relatively close to the center point of the circular path along which at least one circular segment extends, and thus relatively close to an axis of rotation of a rotor of the machine-gearbox arrangement. This enables the use of gear wheels of a relatively small diameter for the first gear wheel and the second gear wheel of the machine-gearbox arrangement, and thus a relatively free design of a gear stage formed by the first gear wheel and the second gear wheel.

Preferably, the stator body is rotationally symmetric in relation to a center point of the circular path, so that the stator can be installed in several orientations, which is advantageous for handling the stator body during assembly. In a particularly preferred design, the stator body is also mirror-symmetric in relation to a mirror plane running through the center point of the circular path and intersecting the circular path.

In a preferred embodiment, the stator body comprises two opposing circular segments and two opposing recess segments. Preferably, both the two circular segments and the two recess segments each have the same shape in order to create a symmetrical stator body that is easy to handle during assembly. The stator windings are preferably arranged in two stator winding groups, with one of the two stator winding groups being arranged on each circular segment. Preferably, the two stator winding groups each have the same number of stator windings, particularly preferably three stator windings each. This makes it possible to drive the rotor of an electric machine realized with the stator according to the invention relatively uniformly, despite the two recess segments on which there are no stator windings.

To reduce eddy current losses, the stator body is preferably designed as a laminated core, i.e. formed from a large number of stacked and interconnected, preferably identically shaped, sheet metal parts.

In a preferred embodiment, at least one radially inwardly projecting magnetic field guiding element is formed on the at least one recess segment of the stator body. At least one magnetic field guiding element is integral with the stator body, i.e. it is formed either by the same monolithic solid body or by the same laminated core as the stator body. Preferably, a plurality of magnetic field guiding elements is formed on each recess segment. Preferably, all magnetic field guiding elements have the same radial distance to the center point of the circular path as the stator teeth carrying the stator windings. At least one magnetic field guiding element can be used to achieve an improved magnetic field course in the stator of an electric machine realized with the stator according to the invention as compared to a stator without magnetic field guiding elements.

Preferably, the stator teeth supporting the stator windings are integral with the stator body. This means that in the case of a stator body designed as a monolithic solid body, the stator teeth are formed in one piece with the stator body, i.e. are formed by the same monolithic solid body, or that in the case of a stator body designed as a laminated core, the stator teeth are formed by the same laminated core, i.e. by the same laminations, as the stator body. During assembly, the stator windings may either be applied directly to the stator teeth, preferably by needle winding, or they may be wound onto a carrier and slipped onto the stator teeth. However, it is also conceivable in principle that separate stator teeth, preferably already provided with a stator winding, are attached to the stator body.

In a preferred embodiment, the stator windings are arranged in a plurality of stator winding groups, wherein stator windings of a stator winding group which are adjacent to one another in the circumferential direction have an angular distance from one another which is smaller than an angular distance between stator windings adjacent to one another in the circumferential direction of different stator winding groups. The angular distance between the stator windings of a stator winding group is therefore smaller than the angular distance between the stator winding groups. The angular distance is to be understood here as the distance in the circumferential direction between the center lines of the two stator windings under consideration, wherein the circumferential direction in turn refers to the circular path along which at least one circular segment runs.

In principle, stator windings adjacent to one another in the circumferential direction within a stator winding group may have an angular distance in the range of 30° to 60°. Preferably, however, the stator windings adjacent to one another in the circumferential direction within a stator winding group have an angular distance in the range of 32.5° to 40° from one another instead of the usual angular distance of 30° for a conventional stator with twelve windings distributed along the entire circumference of the stator body. This makes it possible to increase the cogging torque of the rotor in an electric machine realized with the stator according to the invention, and thus to realize a self-locking electric machine. In addition, the larger angular distance also allows the use of stator windings with a larger number of turns.

In a preferred embodiment, the stator according to the invention additionally comprises a plastic body formed by overmolding the stator body. The plastic body typically serves as electrical insulation between the stator windings and the stator teeth that support them. Furthermore, if the stator body is designed as a laminated core, the sheet metal parts of the laminated core are also reliably held together by the plastic body. Alternatively, it is also conceivable in principle that the plastic body is realized in the form of two half-shells, which are pushed onto the stator body.

Typically, the stator according to the invention additionally comprises several contact elements for electrically contacting the stator windings. In principle, the contact elements may be arranged anywhere on the stator. Preferably, however, the contact elements are arranged in the angular region of a recess segment, with the contact elements preferably being arranged at least partially in an area between the respective recess segment and the course of the circular path. This enables a space-saving arrangement of the contact elements.

If the stator comprises a plastic body as described above, the contact elements are preferably attached to the plastic body. The contact elements are particularly preferably embedded in the plastic body, i.e. molded through the plastic body or pressed into the plastic body, and thus reliably attached to the plastic body.

The electric machine according to the invention comprises a stator according to the invention and a rotor which is arranged within the stator body of the stator according to the invention so as to be rotatable about a rotor axis. The rotor preferably comprises one or more permanent magnets, which interact with a magnetic field generated by the stator windings during operation of the electric machine according to the invention. The rotor axis of rotation preferably runs through the center point of the circular path along which at least one circular segment of the stator body runs.

With the stator according to the invention, the electric machine according to the invention enables a relatively free and space-saving design of the gear stage formed by the first gear wheel and the second gear wheel in a machine-gearbox arrangement realized with the electric machine according to the invention.

The machine-gearbox arrangement according to the invention comprises an electric machine according to the invention with a stator according to the invention.

The machine-gearbox arrangement according to the invention further comprises a first gear wheel which is arranged to rotate with the rotor of the electric machine according to the invention. Preferably, the first gear wheel is arranged coaxially to the rotor.

The machine-gearbox arrangement according to the invention further comprises a second gear wheel which is arranged in engagement with the first gear wheel, i.e. together with the first gear wheel forms a gear stage, in particular a spur gear stage. Preferably, the second gear wheel has a larger diameter and therefore a larger number of teeth than the first gear wheel.

The machine-gearbox arrangement according to the invention further comprises an element which is non-rotatably connected to the second gear wheel. The element is preferably formed in one piece, i.e. monolithically, with the second gear wheel, but may in principle also be a separate component connected to the second gear wheel in a rotationally fixed manner. The element may, for example, be a third gear wheel or a gear shaft on which the second gear wheel is mounted. According to the invention, the element is arranged at least partially in an area between a recess segment of the stator according to the invention and the circular path along which the at least one circular segment of the stator according to the invention extends. As described above, this makes it possible to arrange the element relatively close to the axis of rotation of the rotor, which in turn allows the use of gears of a relatively small diameter and thus a relatively free design of the gear stage formed by the first gear wheel and the second gear wheel.

### BRIEF DESCRIPTION OF THE DRAWINGS

An exemplary embodiment of the present invention is described below with reference to the attached figures. In the figures:

FIG. 1 shows a schematic top view of a stator according to the invention;

FIG. 2 shows a schematic exploded view of the stator of FIG. 1;

FIG. 3 shows a schematic top view of a stator body of the stator of FIG. 1;

FIG. 4 shows a schematic perspective view of an electric machine according to the invention, comprising the stator of FIG. 1 to FIG. 3;

FIG. 5 shows a schematic perspective view of a machine-gearbox arrangement according to the invention, comprising the electric machine of FIG. 4;

FIG. 6 shows a schematic top view of an alternative stator according to the invention; and

FIG. 7 shows a schematic top view of a stator body of the stator of FIG. 6.

### DETAILED DESCRIPTION OF THE CURRENT EMBODIMENTS

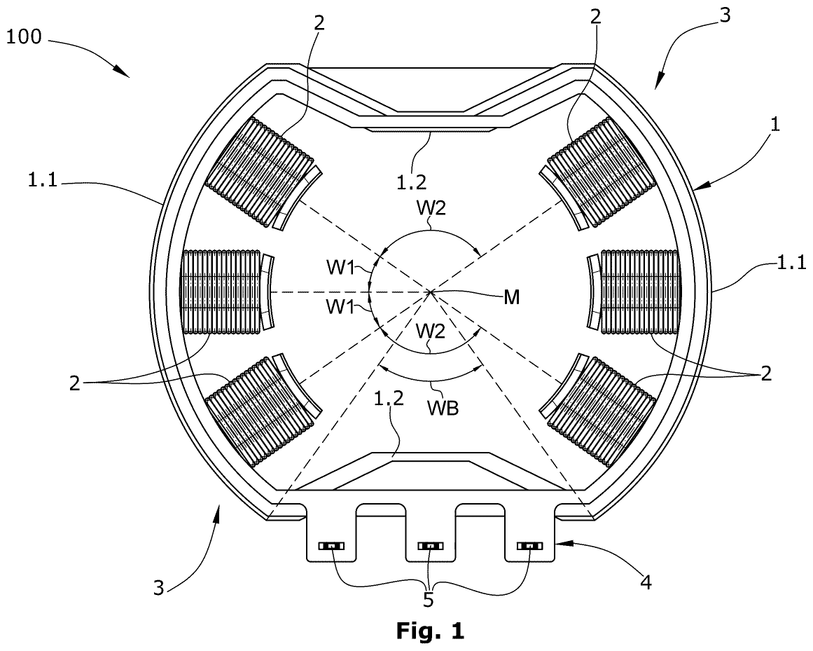

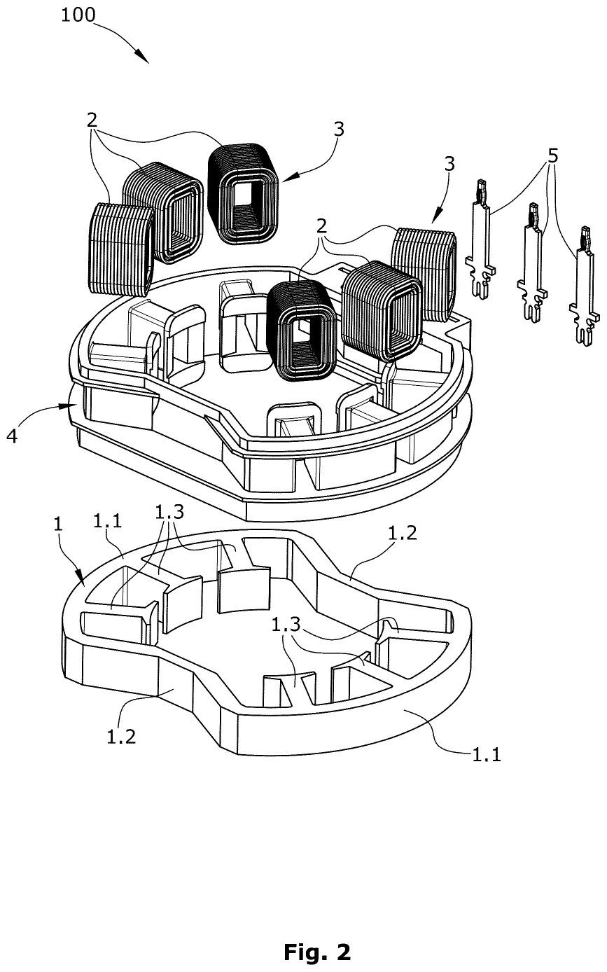

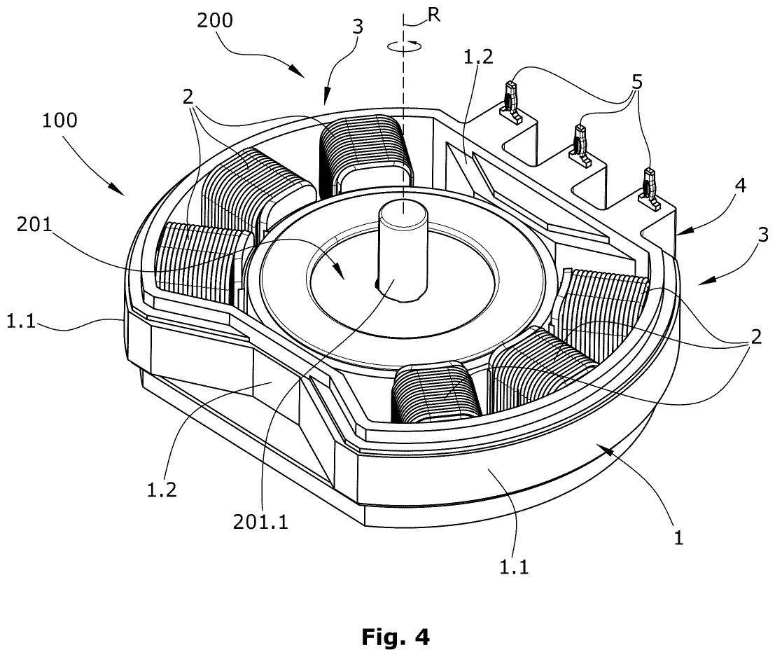

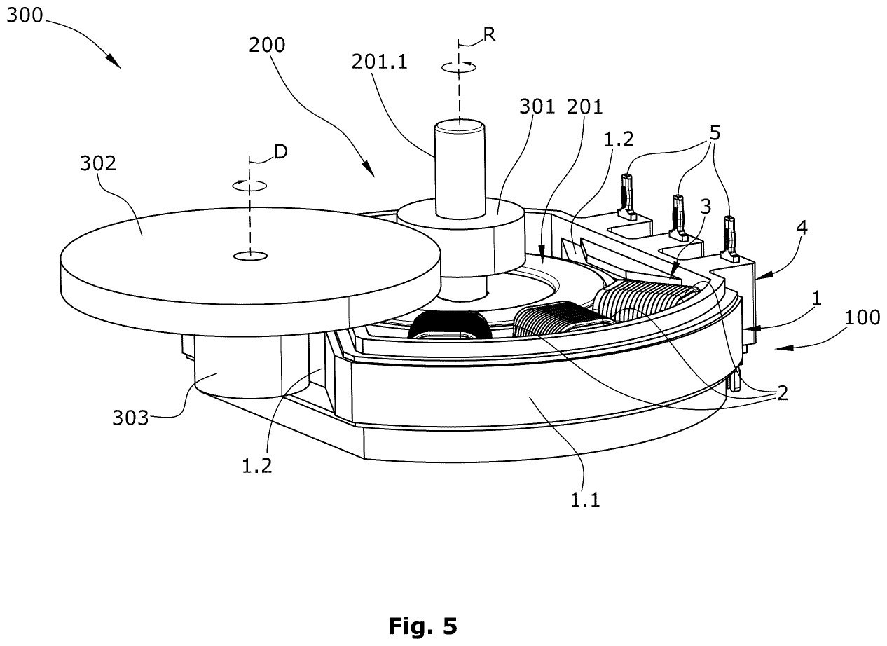

FIG. 1 to FIG. 5 show a stator 100 according to the invention for an electric machine 200 according to the invention shown in FIG. 4 and FIG. 5.

The stator 100 comprises an annular stator body 1, which is designed as a laminated core, i.e. consists of a large number of sheet metal parts stacked on top of one another and not shown individually here.

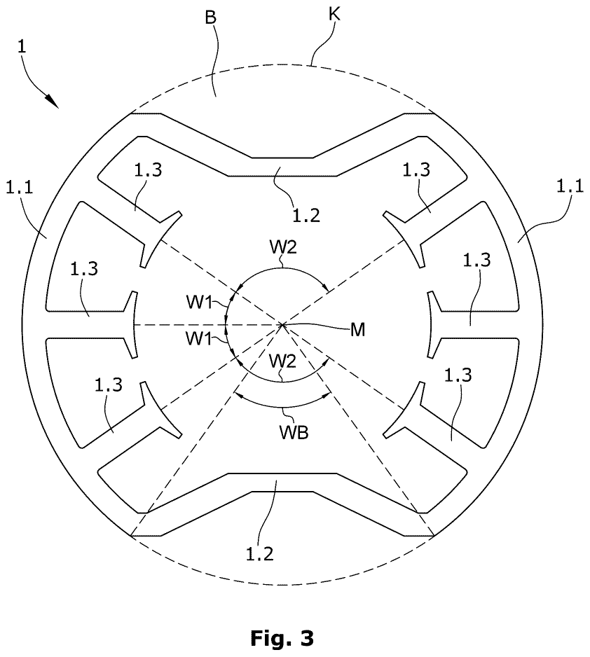

The stator body 1 comprises two opposing circular segments 1.1, each of which runs along a circular path K shown as a dashed line in FIG. 3, and two opposing recess segments 1.2, each of which deviates radially inwards from the circular path K, i.e. in the direction of a center point M of the circular path K.

The stator body 1 also comprises six integrally formed stator teeth 1.3 projecting radially inwards from the two circular segments 1.1, whereby three stator teeth 1.3 are formed on each of the two circular segments 1.1.

The stator teeth 1.3 are arranged on the circular segments 1.1 in such a way that the center axes of adjacent stator teeth 1.3 arranged on the same circular segment 1.1 each run at an angular distance W1 of 35° from one another.

The stator body 1 is rotationally symmetrical in relation to the center point M of the circular path K.

The stator 100 further comprises six stator windings 2 which are arranged on the stator body 1, in particular on the stator teeth 1.3 formed on the circular segments 1.1 of the stator body 1, each of the stator windings 2 being arranged on one of the stator teeth 1.3 and held by the respective stator tooth 1.3 in such a way that center axes of the stator windings 2 correspond to the center axes of the stator teeth 1.3.

The stator windings 2 are therefore arranged in two stator winding groups 3, wherein each stator winding group 3 comprises those three stator windings 2 that are arranged together on one of the two circular segments 1.1.

The stator windings 2 adjacent to one another in the circumferential direction within a stator winding group 3 each have the angular distance W1 from one another, and the two outermost stator windings 2 of a stator winding group 3 have an angular distance W2 of 110° from the stator winding 2 of the other stator winding group 3, which is adjacent in the circumferential direction.

The stator 100 further comprises a plastic body 4 formed by overmolding the stator body 1, wherein the plastic body 4 holds the stator body 1, which is formed as a laminated core, together and further insulates the stator body 1 electrically from the stator windings 2.

The stator 100 further comprises three contact elements 5 for external electrical contacting of the stator windings 2, wherein the contact elements 5 are embedded in the plastic body 4 in an angular region WB of the lower recess segment 1.2 of the stator body 1 with respect to the representation in FIG. 1, wherein the contact elements 5 are also molded through the plastic body 4.

The electric machine 200 according to the invention shown in FIG. 4 and FIG. 5 comprises, in addition to the stator 100, a permanent-magnet rotor 201, which comprises a rotor shaft 201.1 and which is arranged to be rotatable about a rotor axis of rotation R extending through the center point M of the circular path K within the stator body 1 of the stator 100.

FIG. 5 shows a machine-gearbox arrangement 300 according to the invention, realized with the electrical machine 200 according to the invention.

The machine-gearbox arrangement 300 comprises a first gear wheel 301, which is attached to the rotor shaft 201.1 of the rotor 201 and is thus arranged to rotate with the rotor 201.

The machine-gearbox arrangement 300 further comprises a second gear wheel 302, which is rotatable about an axis of rotation D and is arranged in engagement with the first gear wheel 301.

An element 303, which in the present exemplary embodiment is a third gear wheel, is attached or molded to the second gear wheel 302, wherein the element 303 is arranged at least partially in an area B marked in FIG. 3 between the upper recess segment 1.2 of the stator body 1 and the circular path K in the representation in FIG. 3.

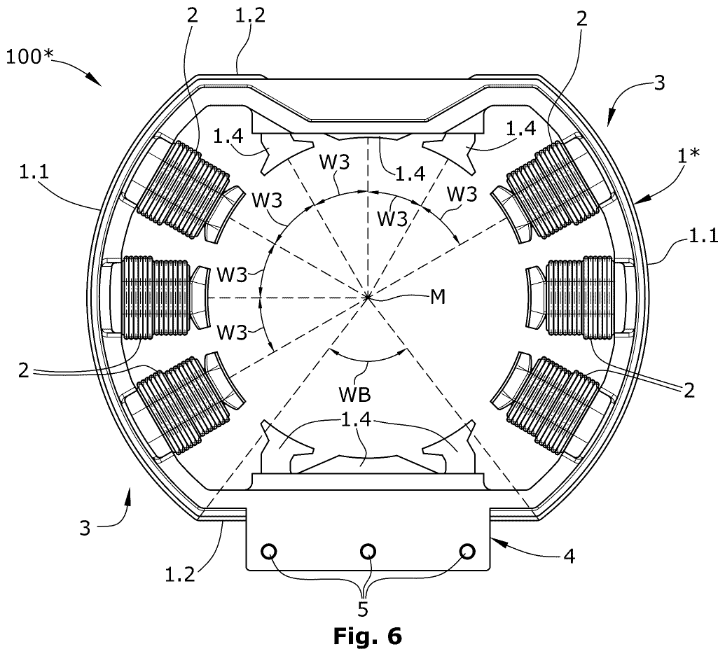

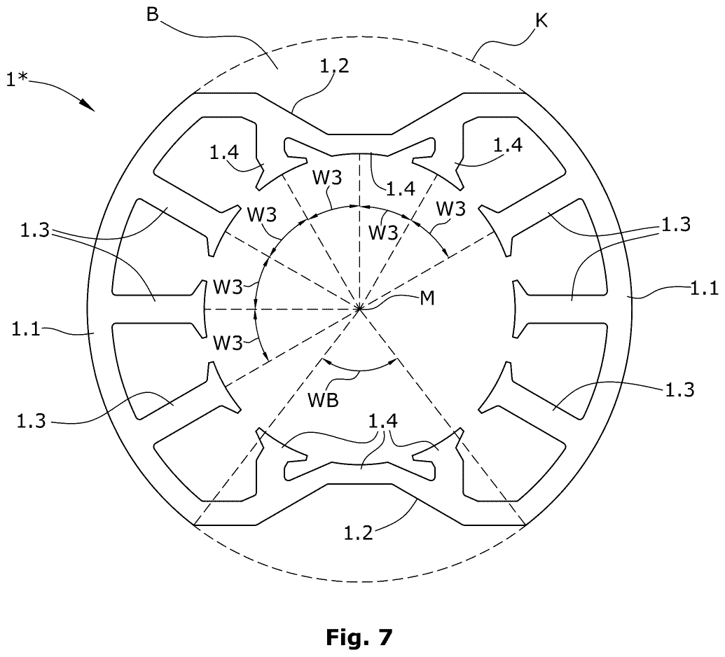

FIG. 6 shows a further stator 100* according to the invention, and FIG. 7 shows a stator body 1* of the stator 100*, wherein the corresponding features from FIG. 1 to FIG. 5 are used to describe the stator 100* or the stator body 1* for features that are known to be identical or similar to the stator 100 or the stator body 1.

The stator 100* essentially differs from the stator 100 in that the stator body 1* has three integral magnetic field guiding elements 1.4 on each of the two recess segments 1.2, which protrude radially inwards, i.e. in the direction of the center point M of the circular path K, with the center axes of adjacent magnetic field guiding elements 1.4 each having an angular distance W3 of 30° from one another.

The stator 100* further differs from the stator 100 in that the stator windings 2 each likewise have the angular distance W3 from an adjacent stator winding 2 or from an adjacent magnetic field guiding element 1.4.

### LIST OF REFERENCE NUMBERS

100; 100* Stator
1; 1* Stator body
1.1 Circular segments
1.2 Recess segments
1.3 Stator teeth
1.4 Magnetic field guiding elements
2 Stator windings
3 Stator winding groups
4 Plastic body
5 Contact elements
200 Electric machine
201 Rotor
201.1 Rotor shaft
300 Machine-gearbox arrangement
301 First gear wheel
302 Second gear wheel
303 Gear shaft
B Area
D Axis of rotation
K Circular path
R Rotor axis of rotation
W1 Angular distance
W2 Angular distance
W3 Angular distance
WB Angular region

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A stator for an electric machine, comprising:
an annular stator body;
a plurality of stator windings arranged on the stator body;
wherein the stator body comprises:
at least one circular segment which extends along a circular path, and
at least one recess segment which has a radially inward deviating course from the circular path, wherein the plurality of stator windings are arranged on the at least one circular segment.

2. The stator of claim 1, wherein the stator body is rotationally symmetrical with respect to a center point of the circular path.

3. The stator of claim 1, wherein:
the at least one circular segment comprises two opposing circular segments; and
the at least one recess segment comprises two opposing recess segments.

4. The stator of claim 1, wherein the stator body is formed as a laminated core.

5. The stator of claim 1, wherein at least one radially inward projecting magnetic field guiding element is formed on the at least one recess segment.

6. The stator of claim 1, wherein stator teeth supporting supporting the stator winding are formed integrally with the stator body.

7. The stator of claim 1, wherein the plurality of stator windings are arranged in a plurality of stator winding groups, and wherein adjacent ones of the plurality of stator windings within a respective one of the plurality of stator winding groups have an angular distance from one another which is smaller than an angular distances between adjacent ones of the stator winding groups.

8. The stator of claim 7, wherein adjacent ones of the plurality of stator windings within a respective one of the plurality of stator winding groups are separated from each other by an angular distance in the range of 32.5° to 40° from one another.

9. The stator of claim 1, further comprising a plastic body that is overmolded onto the stator body.

10. The stator of claim 9, further comprising a plurality of contact elements for electrically contacting the stator windings, wherein the plurality of contact elements are arranged in the angular region of a recess segment.

11. The stator of claim 10, wherein the contact elements are attached to the plastic body.

12. An electric machine comprising:
the stator according to claim 1; and
a rotor, the rotor being arranged within the stator body so as to be rotatable about a rotor axis of rotation.

13. A machine-gearbox arrangement comprising:
the electric machine according to claim 12;
a first gear wheel, which is arranged to rotate with the rotor;
a second gear wheel, which is arranged in engagement with the first gear wheel; and
an element which is connected to the second gear wheel in a rotationally fixed manner, wherein the element is arranged at least partially in an area between the at least one recess segment and the circular path.
